(19) United States
(12) Patent Application Publication
(10) Pub. No.: US 2025/0030575 A1
(43) Pub. Date: Jan. 23, 2025

(54) MEGAWATT CHARGING SYSTEM ADAPTER

(71) Applicant: ABB E-mobility B.V., Delft (NL)

(72) Inventors: Cliff Fietzek, Arlington, VA (US); Jason Gies, Cary, NC (US)

(21) Appl. No.: 18/355,762

(22) Filed: Jul. 20, 2023

(51) Int. Cl. H04L 12/40

(52) U.S. Cl. CPC H04L 12/40; H04L 2012/40273

(57) ABSTRACT

An adapter for an electric charging system of an electric vehicle is provided. The adapter includes an input interface configured to couple to a charger, an output interface configured to couple to a charging inlet of an energy storage device, and at least one power conductor connected to the input interface and to the output interface. The least one power conductor is configured to convey current between the charger and the charging inlet. The adapter further includes a communication conversion unit configured to receive a first communication signal transmitted from the charger via the input interface, the first communication signal having a first protocol, translate the first communication signal to a second communication signal having a second protocol, and transmit the second communication signal to the charging inlet via the output interface.

### BACKGROUND

The field of the invention relates generally to charging systems for energy storage devices, and more particularly, to a megawatt charging system adapter for charging electric vehicles (EVs).

Electric vehicles have become popular. With the growing popularity of EVs, known systems and methods are disadvantaged in some aspects in meeting the needs of EVs and improvements are desired.

### BRIEF DESCRIPTION

In one aspect, an adapter for an electric charging system of an electric vehicle is provided. The adapter includes an input interface configured to couple to a charger configured for communicating using a first protocol, an output interface configured to couple to a charging inlet of an energy storage device configured for communicating using a second protocol, and at least one power conductor connected to the input interface and to the output interface. The least one power conductor is configured to convey current between the charger and the charging inlet. The adapter further includes a communication conversion unit configured to receive a first communication signal transmitted from the charger via the input interface, the first communication signal having the first protocol, translate the first communication signal to a second communication signal having the second protocol, and transmit the second communication signal to the charging inlet via the output interface.

In another aspect, a communication conversion unit for an adapter for an electric charging system is provided. The adapter includes an input interface configured to couple to a charger configured for communicating using a first protocol, an output interface configured to couple to a charging inlet of an energy storage device configured for communicating using a second protocol, and at least one power conductor connected to the input interface and to the output interface. The at least one power conductor is configured to convey current between the charger and the charging inlet. The communication conversion unit includes a processor configured to receive a first communication signal transmitted from the charger via the input interface, the first communication signal having the first protocol, translate the first communication signal to a second communication signal having the second protocol, and transmit the second communication signal to the charging inlet via the output interface.

In another aspect, a method for charging an energy storage device performed by an adapter for an electric charging system is provided. The adapter includes a communication conversion unit, an input interface configured to couple to a charger configured for communicating using a first protocol, an output interface configured to couple to a charging inlet of the energy storage device configured for communicating using a second protocol, and at least one power conductor connected to the input interface and to the output interface. The at least one power conductor is configured to convey current between the charger and the charging inlet. The method includes receiving, by the communication conversion unit, a first communication signal transmitted from the charger via the input interface, the first communication signal having the first protocol, translating, by the communication conversion unit, the first communication signal to a second communication signal having the second protocol, and transmitting, by the communication conversion unit, the second communication signal to the charging inlet via the output interface.

### BRIEF DESCRIPTION OF THE DRAWINGS

FIG. 1 is a block diagram of an example charging system.

FIG. 2 is a schematic diagram of an example charging adapter for use in the charging system shown in FIG. 1.

FIG. 3A is a perspective view of an example charging adapter for use in the charging system shown in FIG. 1 that includes a Tesla NACS connector.

FIG. 3B is a perspective view of another example charging adapter for use in the charging system shown in FIG. 1 that includes a CCS2 connector.

FIG. 3C is a perspective view of another example charging adapter for use in the charging system shown in FIG. 1 that includes a CCS1 connector.

FIG. 4 is a flow chart illustrating an example method for charging an energy storage device using the charging system shown in FIG. 1.

### DETAILED DESCRIPTION

Example embodiments of the present disclosure include an adapter for an electric charging system. The adapter includes an input interface configured to couple to a charger and an output interface configured to couple to a charging inlet of an energy storage device, such as the energy storage system of an EV or hybrid-electric vehicle. The adapter further includes at least one power conductor connected to the input interface and to the output interface. The at least one power conductor configured to convey current between the charger and the charging inlet to charge the energy storage device. In the example embodiments, the input interface and output interface are be constructed according to different connector formats. For example, the output interface may have a high-power format (e.g., Megawatt Charging System (MCS)), while the input interface may have a low-power and/or legacy format, thereby enabling a vehicle having a high-power (e.g., MCS) charging inlet to be charged using a charger having a low-power and/or legacy format connector.

Energy storage devices, such as those used to supply energy to an EV, generally include an interface though which power may be supplied to the energy storage device from an external source. These interfaces may include one or more conductors for carrying electrical power (e.g., direct current (DC) power), and may further include one or more conductors for carrying communications signals, such as those used to control charging of the energy storage device. Certain predefined formats (e.g., Combined Charging System Type 1 (CCS1), Combined Charging System Type 2 (CCS2), Tesla North American Charging Standard (NACS), MCS, etc.) define specific arrangements these power and communication conductors and their corresponding connector pins, as well as other components of the interface (e.g., protective insulators, mechanical fasteners, and the like). Accordingly, each of these protocols has different performance characteristics. For example, certain formats may be capable of carrying greater power, current, and/or voltage levels to enable faster charging.

In some circumstances, new EVs may be deployed that have charging interface formats (e.g., MCS) that enable high-speed charging, but do not yet have widespread available charging locations. One possible solution would be to include multiple (e.g., both high-speed and legacy) charging interfaces on the EV. However, this would greatly increase the cost and complexity of the EV charging system. To address this problem, the example adapter described herein enables EVs with a single charging port having a new charging format, such as MCS, to be charged using chargers having legacy charging formats that are already widely deployed.

In many cases, the legacy charging formats use different communication protocols than the new charging formats. For example, an EV having an MCS charging format may be configured for communicating using dedicated communication pins, while the legacy charger may utilize a different charging format, such as a power line communication (PLC) format that does not utilize dedicated communication pins. As described in further detail below, the adapter described herein may address this problem by translating communication signals that are transmitted between the charger and the EV from one communication protocol to another to enable EVs to be charged by chargers that utilize a different communication protocol than the vehicles.

More specifically, in the example embodiments, the adapter is capable of translating communication signals between a protocol used by the input interface and a protocol used by the output interface. The adapter includes a communication conversion unit configured to receive a first communication signal having a first protocol that transmitted from the charger via the input interface, translate the first communication signal to a second communication signal having a second protocol, and transmit the second communication signal to the charging inlet via the output interface. Similarly, the communication conversion unit is configured to receive communication signals from the charging inlet of the EV having the second protocol, translate the communication signals having the second protocol to the first protocol, and transmit the translated signals to the charger. In embodiments in which the input interface and/or output interface include one or more dedicated communication pins (e.g., as with an MCS connector) for carrying these communication signals, the communication conversion unit is communicatively coupled to these communication pins by respective communication conductors.

Accordingly, a vehicle with a high-speed charging format, such as MCS, can be charged using a charger that has a legacy charging format, such as CCS1, CCS2, or Tesla NACS, even if the high-speed charging configuration and legacy charging format utilize different communication protocols.

The systems and methods described herein are advantageous in enabling a vehicle with a high-speed charging format to be charged by a charger that has a legacy charging format, and enabling a vehicle with a legacy charging format to be charged by a charger with a high-speed charging format, without the requirement of multiple charging interfaces on the EV, thereby reducing the costs in designing and manufacturing EVs and providing a relatively low cost solution to increase the availability of chargers for an EV in the fast expanding EV market.

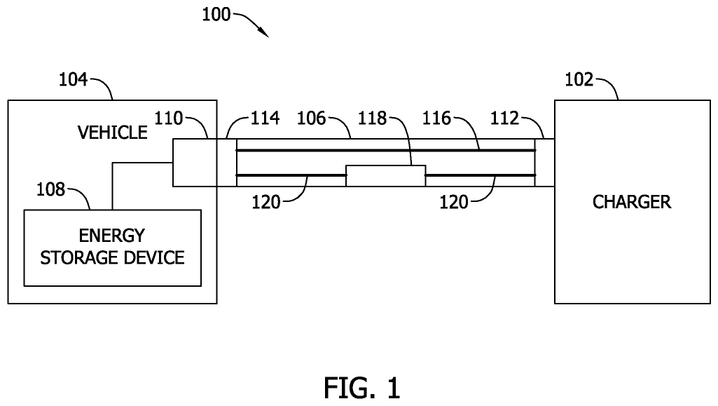

FIG. 1 is a block diagram of an example charging system 100. In the example embodiment, charging system 100 includes a charger 102, a vehicle 104, and a charging adapter 106. Charger 102 is configured to supply electrical power to vehicle 104 through charging adapter 106.

In the example embodiment, vehicle 104 includes an energy storage device 108, such as a battery, which may store electrical energy for use in powering vehicle 104. Accordingly, vehicle 104 may be an electric vehicle (EV). An EV may be a battery electric vehicle (BEV), a plug-in electric vehicle, or a hybrid electric vehicle (HEV), or any other type of vehicle capable of being charged from an external electrical source such as charger 102. Vehicle 104 further includes a charging inlet 110 that is configured to couple with charging adapter 106 and to convey electric current supplied from charging adapter 106 to energy storage device 108. Charging inlet 110 is further configured such that the coupling between charging inlet 110 and charging adapter 106 enables a transmission of communication signals between charger 102 and vehicle 104 through charging adapter 106, as described in further detail below. In some embodiments, charging inlet 110 is configured according to a high-speed charging format, such as MCS.

In the example embodiment, charging adapter 106 includes an input interface 112 and an output interface 114. Input interface 112 is configured to engage with charger 102, and may be structured according to a charging connector format such as, for example, CCS1, CCS2, or Tesla NACS. Output interface 114 is configured to engage with charging inlet 110 of vehicle 104, and may be structured according to a charging connector format different than the format of input interface 112. For example, in some embodiments, output interface 114 has an MCS connector format. In some embodiments, output interface 114 has a format capable of higher power charging than input interface 112. For example, output interface 114 may have an MCS format, while input interface 112 may have a CCS1, CCS2, or Tesla NACS format. In such embodiments, while the charging power and speed may be restricted to that of input interface 112, vehicles having a higher power charging connector format may nonetheless be safely charged using a charger having a lower power and/or legacy charging format.

In the example embodiment, charging adapter 106 further includes at least one power conductor 116 configured to convey current between charger 102 and vehicle 104. The number of power conductors 116 may depend on the connector format of input interface 112 and/or output interface 114. In some embodiments, charging adapter 106 includes at least three power conductors 116 corresponding to a positive DC pin, a negative DC pin, and a protective earth (PE) pin. In such embodiments, each power conductor 116 is routed from its corresponding pin on input interface 112 to its corresponding pin on output interface 114.

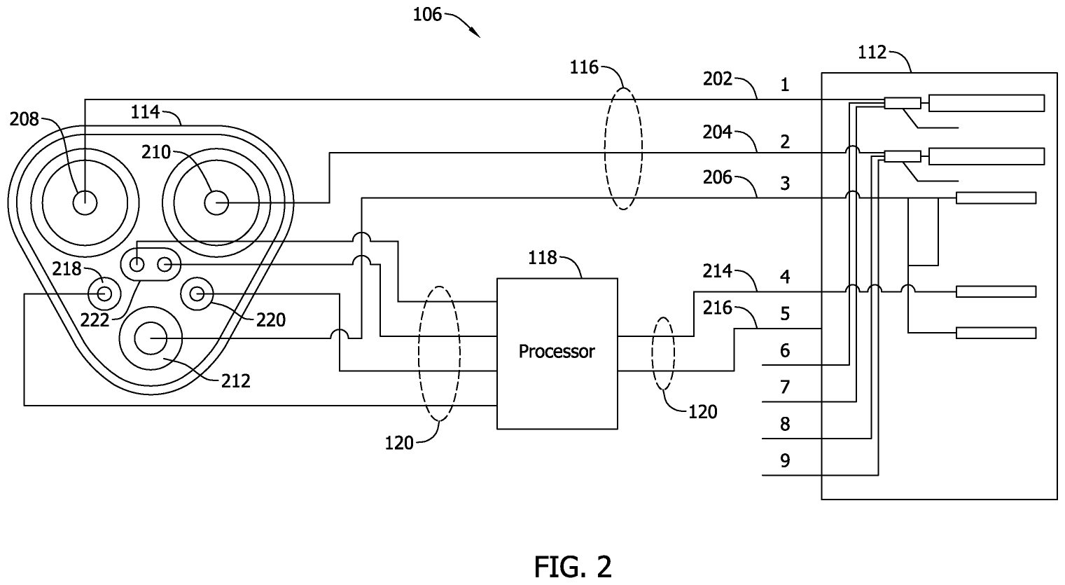

In the example embodiment, charging adapter 106 further includes a communication conversion unit 118. In some embodiments, communication conversion unit 118 includes a processor that may perform some or all of the functionality described with respect to communication conversion unit 118. Communication conversion unit 118 facilitates a transmission of communication signals between charger 102 and charging inlet 110 when input interface 112 and output interface 114 are of different formats by translating communication signals from one format to another. Communication conversion unit 118 is configured to receive a first communication signal having a first protocol and transmitted from charger 102 via input interface 112, translate the first communication signal to a second communication signal having a second protocol, and transmit the second communication signal to charging inlet 110 via the output interface 114. Similarly, in some embodiments, communication conversion unit 118 is configured to receive communication signals from transmitted from charging inlet 110 via output interface 114 having the second protocol, translate the communication signals having the second protocol to the first protocol, and transmit the translated signals to charger 102 via input interface 112. For example, in embodiments in which output interface 114 is a MCS connector, output interface 114 may include dedicated Coms pins (shown in and described in further detail below with respect to FIG. 2). In such embodiments, communication conversion unit 118 translates a communication signal (e.g., a power line communication (PLC), differential PLC, Ethernet, controller area network (CAN) signal) transmitted via input interface 112 to a signal capable of being transmitted through the dedicated Coms pins.

In some embodiments, charging adapter 106 further includes one or more communication conductors 120 that connect communication conversion unit 118 to input interface 112 and/or output interface 114. Additionally or alternatively, in some embodiments, communication signals may be transmitted over power conductors 116. Accordingly, while FIG. 1 depicts communication conversion unit 118 as being connected to input interface 112 and output interface 114 by respective communication conductors 120, it should be appreciated that communication conversion unit 118 may in some embodiments be connected to one or neither of input interface 112 and output interface 114 via communication conductors 120. For example, communication conversion unit 118 may be integrated into one of input interface 112 or output interface 114 and/or transmit and receive communication signals over power conductor 116. In some embodiments, communication conductors 120 may include one or more twisted pairs or other types of transmission lines capable of carrying signals having, for example, an Ethernet, Controller Area Network, or differential PLC protocol.

FIG. 2 is a schematic diagram of an example embodiment of charging adapter 106, which generally functions as described with respect to FIG. 1. In the example embodiment shown in FIG. 2, charging adapter 106 is configured for coupling a vehicle equipped with an MCS charging inlet to a charger having a CCS1 connector. While FIG. 2 illustrates an embodiment that utilizes an MCS connector and a CCS1 connector, other embodiments of charging adapter 106 may utilize different types of connectors.

As shown in FIG. 2, in the example embodiment, input interface 112 includes an input positive DC pin 202, an input negative DC pin 204, and an input PE pin 206, and output interface 114 correspondingly includes an output positive DC pin 208, an output negative DC pin 210, and an output PE pin 212. Input positive DC pin 202 is electrically coupled to output positive DC pin 208, input negative DC pin 204 is electrically coupled to output negative DC pin 210, and input PE pin 206 is electrically coupled to output PE pin 212 via respective power conductors 116, enabling DC power to be transferred via charging adapter 106. In some embodiments, in addition to DC power, one or more of power conductors 116 may be used to transmit a PLC signal.

In the example embodiment, input interface 112 further includes an input control pilot (CP) pin 214 and an input proximity pilot (PP) pin 216, and output interface 114 further includes an output CP pin 218 and an output PP pin 220. Input CP pin 214 and output CP pin 218, and input PP pin 216 and output PP pin 220, are communicatively connected via communication conversion unit 118 using respective communication conductors 120. Input CP pin 214 and output CP pin 218 are configured to carry a CP signal, which may be used to transfer information such as a charging level, a maximum charging current, and commands to start or stop charging between charger 102 and vehicle 104. Input PP pin 216 and output PP pin 220 are configured to carry a PP signal, which indicates a connection is present between charger 102 and vehicle 104.

In the example embodiment, output interface 114 further includes one or more dedicated coms pins 222, which are communicatively coupled to communication conversion unit 118 via respective communication conductors 120. In some embodiments, communication conductors 120 that are connected to coms pins 222 may include one or more twisted pairs or other types of transmission lines. communication conversion unit 118 is configured to translate communication signals received from input interface 112 to a protocol that may be transmitted to vehicle 104 via dedicated coms pins 222 of output interface 114. For example, communication conversion unit 118 may be configured to convert a single-ended PLC signal received from input interface 112 to an Ethernet, CAN, and/or differential PLC signal, which communication conversion unit 118 may transmit through output interface 114 using at least coms pins 222.

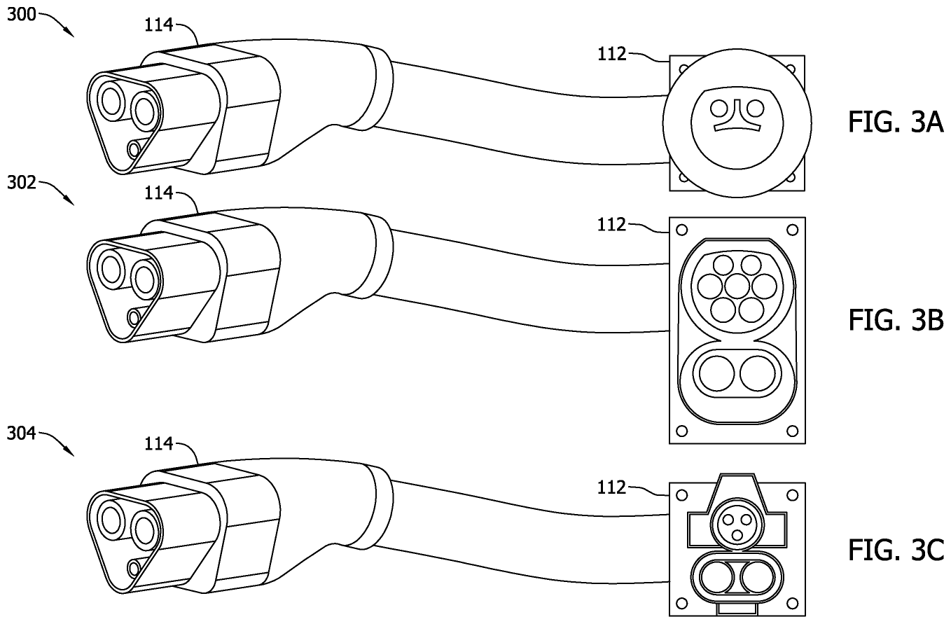

FIGS. 3A, 3B, and 3C each depict a perspective view of a respective embodiment of charging adapter 106. FIG. 3A depicts an example charging adapter 300, which includes an input interface 112 having a Tesla NACS connector format and an output interface 114 having an MCS connector format. FIG. 3B depicts an example charging adapter 302, which includes an input interface 112 having a CCS2 connector format and an output interface 114 having an MCS connector format. FIG. 3C depicts an example charging adapter 304, which includes an input interface 112 having a CCS1 connector format and an output interface 114 having an MCS connector format.

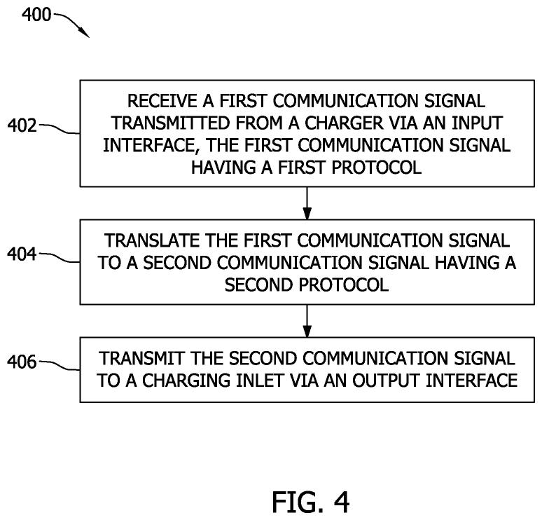

FIG. 4 is a flowchart illustrating an example method 400 for charging an energy storage device (such as energy storage device 108 of vehicle 104) using an adapter (such as charging adapter 106) including a communication conversion unit (such as communication conversion unit 118). The adapter includes an input interface (such as input interface 112) configured to couple to a charger (such as charger 102), an output interface (such as output interface 114) configured to couple to a charging inlet (such as charging inlet 110) of the energy storage device, and at least one power conductor (such as power conductor 116) connected to the input interface and to the output interface and configured to convey current between the charger and the charging inlet.

In the example embodiment, method 400 includes receiving 402 a first communication signal transmitted from the charger via the input interface, the first communication signal having a first protocol. In some embodiments, the first communication signal may be transmitted from the charging inlet via the output interface.

In the example embodiment, method 400 further includes translating 404 the first communication signal to a second communication signal having a second protocol.

In the example embodiment, method 400 further includes transmitting 406 the second communication signal to the charging inlet via the output interface. In some embodiments, the second communication signal may be transmitted to the charger via the input interface.

In some embodiments, the output interface includes an MCS connector.

In some embodiments, the communication conversion unit is integrated into the input interface or the output interface.

In some embodiments, the adapter further includes at least one communication conductor configured to convey the first communication signal from the input interface to the communication conversion unit.

In some embodiments, the adapter further includes at least one communication conductor configured to convey the second communication signal from the communication conversion unit to the output interface. In some such embodiments, the output interface includes at least one dedicated communication pin, wherein each dedicated communication pin is communicatively coupled to the communication conversion unit via a respective one of the communication conductors.

In some embodiments, the second communication signal is transmitted according to an Ethernet, Controller Area Network, or differential power line communication protocol.

In some embodiments, the first communication signal is transmitted from the input interface over the power conductor, and the communication conversion unit is configured to receive the first communication signal via the power conductor. In some such embodiments, the first communication signal is transmitted as a single-ended power line communication signal.

Example embodiments of a charging adapter are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

At least one technical effect of the systems and methods described herein includes (a) an ability to charge an energy storage device and/or vehicle using a charger having a different charging connector format than the energy storage device and/or vehicle by using an adapter that includes an input interface with a first charging connector format and a second interface including a second charging connector format; (b) an ability to charge an energy storage device and/or vehicle having a high-power charger using a low-power charger by using an adapter that includes an input interface with a low-power charging connector format and a second interface including a high-power charging connector format such as an MCS format; and (c) an ability to charge an energy storage device and/or vehicle using a charger having a charging connector that utilizes a different communications protocol than a charging inlet of the energy storage device and/or vehicle by using an adapter that converts a first communication signal of a first type to a second communication signal of a second type.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An adapter for an electric charging system of an electric vehicle, said adapter comprising:
an input interface configured to couple to a charger, the charger configured for communicating using a first protocol;
an output interface configured to couple to a charging inlet of an energy storage device, the energy storage device configured for communicating using a second protocol;
at least one power conductor connected to the input interface and to the output interface, said at least one power conductor configured to convey current between the charger and the charging inlet; and
a communication conversion unit configured to:
receive a first communication signal transmitted from the charger via said input interface, the first communication signal having the first protocol;
translate the first communication signal to a second communication signal having the second protocol; and
transmit the second communication signal to the charging inlet via said output interface.

2. The adapter of claim 1, wherein said output interface comprises a Megawatt Charging System (MCS) connector.

3. The adapter of claim 1, wherein said communication conversion unit is integrated into said input interface or said output interface.

4. The adapter of claim 1, further comprising at least one communication conductor configured to convey the first communication signal from said input interface to said communication conversion unit.

5. The adapter of claim 1, further comprising at least one communication conductor configured to convey the second communication signal from said communication conversion unit to said output interface.

6. The adapter of claim 5, wherein said output interface comprises at least one dedicated communication pin, wherein each dedicated communication pin of said at least one dedicated communication pin is communicatively coupled to said communication conversion unit via a respective one of said at least one communication conductor.

7. The adapter of claim 5, wherein the second communication signal is transmitted according to an Ethernet, Controller Area Network, or differential power line communication protocol.

8. The adapter of claim 1, wherein the first communication signal is transmitted from said input interface over the power conductor, and wherein said communication conversion unit is configured to receive the first communication signal via the power conductor.

9. The adapter of claim 8, wherein the first communication signal is transmitted as a single-ended power line communication signal.

10. A communication conversion unit for an adapter for an electric charging system, the adapter including an input interface configured to couple to a charger configured for communicating using a first protocol, an output interface configured to couple to a charging inlet of an energy storage device configured for communicating using a second protocol, and at least one power conductor connected to the input interface and to the output interface, the at least one power conductor configured to convey current between the charger and the charging inlet; wherein said communication conversion unit comprises a processor configured to:
receive a first communication signal transmitted from the charger via the input interface, the first communication signal having the first protocol;
translate the first communication signal to a second communication signal having the second protocol; and
transmit the second communication signal to the charging inlet via the output interface.

11. The communication conversion unit of claim 10, wherein said output interface includes a Megawatt Charging System (MCS) connector.

12. The communication conversion unit of claim 10, wherein said processor is integrated into the input interface or the output interface.

13. The communication conversion unit of claim 10, wherein at least one communication conductor is configured to convey the first communication signal from the input interface to said processor.

14. The communication conversion unit of claim 10, wherein at least one communication conductor is configured to convey the second communication signal from said processor to the output interface.

15. The communication conversion unit of claim 14, wherein the output interface includes at least one dedicated communication pin, and wherein each dedicated communication pin of the at least one dedicated communication pin is communicatively coupled to said processor via a respective one of said at least one communication conductor.

16. The communication conversion unit of claim 14, wherein said processor is configured to transmit the second communication signal according to an Ethernet, Controller Area Network, or differential power line communication protocol.

17. The communication conversion unit of claim 10, wherein the first communication signal is transmitted from the input interface over the power conductor, and wherein said processor is configured to receive the first communication signal via the power conductor.

18. The communication conversion unit of claim 17, wherein the first communication signal is transmitted as a single-ended power line communication signal.

19. A method for charging an energy storage device performed by an adapter for an electric charging system, the adapter including a communication conversion unit, an input interface configured to couple to a charger configured for communicating using a first protocol, an output interface configured to couple to a charging inlet of the energy storage device configured for communicating using a second protocol, and at least one power conductor connected to the input interface and to the output interface, the at least one power conductor configured to convey current between the charger and the charging inlet, said method comprising:
receiving, by the communication conversion unit, a first communication signal transmitted from the charger via the input interface, the first communication signal having the first protocol;
translating, by the communication conversion unit, the first communication signal to a second communication signal having the second protocol; and
transmitting, by the communication conversion unit, the second communication signal to the charging inlet via the output interface.

20. The adapter of claim 1, wherein said output interface includes a Megawatt Charging System (MCS) connector.
